(19) United States
(12) Patent Application Publication
(10) Pub. No.: US 2012/0242852 A1
(43) Pub. Date: Sep. 27, 2012

(54) Gesture-Based Configuration of Image Processing Techniques

(75) Inventors: David Hayward, Los Altos, CA (US); Chendi Zhang, Mountain View, CA (US)

(73) Assignee: Apple Inc., Cupertino, CA (US)

(21) Appl. No.: 13/052,895

(22) Filed: Mar. 21, 2011

(51) Int. Cl. H04N 5/225; G09G 5/02; G09G 5/00

(52) U.S. Cl. 348/222.1; 345/619; 345/589; 348/E05.024

(57) ABSTRACT

This disclosure pertains to apparatuses, methods, and computer readable medium for mapping particular user interactions, e.g., gestures, to the input parameters of various image filters, while simultaneously setting auto exposure, auto focus, auto white balance, and/or other image processing technique input parameters based on the appropriate underlying image sensor data in a way that provides a seamless, dynamic, and intuitive experience for both the user and the client application software developer. Such techniques may handle the processing of image filters applying location-based distortions as well as those image filters that do not apply location-based distortions to the captured image data. Additionally, techniques are provided for increasing the performance and efficiency of various image processing systems when employed in conjunction with image filters that do not require all of an image sensor's captured image data to produce their desired image filtering effects.

### CROSS-REFERENCE TO RELATED APPLICATION

This application is related to the commonly-assigned U.S. patent application having Atty. Dkt. No. P10550US1 (119-0219US), filed on Mar. 21, 2011, entitled, “Gesture Mapping for Image Filter Input Parameters,” which is hereby incorporated by reference in its entirety.

### BACKGROUND

The disclosed embodiments relate generally to personal electronic devices, and more particularly, to personal electronic devices that capture and display filtered images on a touch screen display.

Today, many personal electronic devices come equipped with digital cameras. Often, these devices perform many functions, and, as a consequence, the digital image sensors included in these devices must often be smaller than sensors in conventional cameras. Further, the camera hardware in these devices often have smaller dynamic ranges and lack sophisticated features sometimes found in larger, professional-style conventional cameras such as manual exposure controls and manual focus. Thus, it is important that digital cameras in personal electronic devices be able to produce the most visually appealing images in a wide variety of lighting and scene situations with limited or no interaction from the user, as well as in the most computationally and cost effective manner possible.

One image processing technique that has been implemented in some digital cameras to compensate for lack of dynamic range and create visually appealing images is known as “auto exposure.” Auto exposure (AE) can be defined generally as any algorithm that automatically calculates and/or manipulates certain camera exposure parameters, e.g., exposure time, gain, or f-number, in such a way that the currently exposed scene is captured in a desirable manner. For example, there may be a predetermined optimum brightness value for a given scene that the camera will try to achieve by adjusting the camera's exposure value. Exposure value (EV) can be defined generally as:

$${log}_{2} \frac{{N}^{2}}{t} ,$$

wherein N is the relative aperture (f-number), and t is the exposure tune (i.e., “shutter speed”) expressed in seconds. Some auto exposure algorithms calculate and/or manipulate the exposure parameters such that a mean, center-weighted mean, median, or more complicated weighted value (as in matrix-metering) of the image's brightness will equal a predetermined optimum brightness value in the resultant, auto exposed scene.

Auto exposure algorithms are often employed in conjunction with image sensors having small dynamic ranges because the dynamic range of light in a given scene, i.e., from absolute darkness to bright sunlight, is much larger than the range of light that image sensors—such as those often found in personal electronic devices—are capable of capturing. In much the same way that the human brain can drive the diameter of the eye's pupil to let in a desired amount of light, an auto exposure algorithm can drive the exposure parameters of a camera so as to effectively capture the desired portions of a scene. The difficulties associated with image sensors having small dynamic ranges are further exacerbated by the fact that most image sensors in personal electronic devices are comparatively smaller than those in larger cameras, resulting in a smaller number of photons that can hit any single photosensor of the image sensor.

In addition to AE, other image processing techniques such as auto focus (AF) and automatic white balance (AWB) may also be performed by the cameras in personal electronic devices. AF and AWB image processing techniques vary widely across implementations and hardware, but are well known in the art, and thus are not described in further detail herein.

As personal electronic devices have become more and more compact, and the number of functions able to be performed by a given device has steadily increased, it has become a significant challenge to design a user interface that allows users to easily interact with such multifunctional devices. This challenge is particularly significant for handheld personal electronic devices, which have much smaller screens than typical desktop or laptop computers.

As such, some personal electronic devices (e.g., mobile telephones, sometimes called mobile phones, cell phones, cellular telephones, and the like) have employed touch-sensitive displays (also known as a “touch screens”) with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include telephoning, video conferencing, e-mailing, instant messaging, blogging, digital photographing, digital video recording, web browsing, digital music playing, and/or digital video playing. Instructions for performing these functions may be included in a computer usable medium or other computer program product configured for execution by one or more processors.

Touch-sensitive displays can provide personal electronic devices with the ability to present transparent and intuitive user interfaces for viewing and navigating GUIs and multimedia content. Such interfaces can increase the effectiveness, efficiency and user satisfaction with activities like digital photography on personal electronic devices. In particular, personal electronic devices used for digital photography and digital video may provide the user with the ability perform various image processing techniques, such as focusing, exposing, optimizing, or otherwise adjusting captured images, as well as image filtering techniques—either in real time as the image frames are being captured by the personal electronic device's image sensor or after the image has been stored in the device's memory.

As image processing capabilities of personal electronic devices continue to expand and become more complex, software developers of client applications for such personal electronic devices increasingly need to understand how the various inputs and states of the device should be translated into input parameters for image filters and other image processing techniques. As a simple example, consider a “black and white” (B&W) image filter, i.e., an image filter that outputs a monochrome black and white extraction of the image sensor's captured color image data to the device's display. An image filter such as the B&W image filter described above does not distort the location of pixels from theft location in “sensor space,” i.e., as they are captured by the camera device's image sensor, to their location in “display space,” i.e., as they are displayed on the device's display. Now suppose that a user wants to indicate a location in display space to base the setting of the camera's AE parameters upon. A user input comprising a single tap gesture at a particular coordinate (x, y) on a touch screen display of the device (i.e., in “display space”) may simply cause the coordinate (x, y) to serve as the center of an exposure metering rectangle over the corresponding image sensor data (i.e., in “sensor space”). The camera may then drive the setting of its exposure parameters for the next captured image frame based on the image sensor data located within the exposure metering rectangle constructed in sensor space. In other words, in the example given above, no translation would need to be applied to the input point location (x, y) in display space and the coordinates of the corresponding point in sensor space used to drive the camera's AE parameters.

With more complex image filters, however, the locations of pixels in display space may be translated by the application of the image filter from their original locations in the image sensor data in sensor space. The translations between sensor space and display space may include: stretching, shrinking, flipping, mirroring, moving, rotating, and the like. Further, users of such personal electronic devices may also want to indicate input parameters to image filters while simultaneously setting auto exposure, auto focus, and/or auto white balance or other image processing technique input parameters based on the appropriate underlying image sensor data.

Accordingly, there is a need for techniques to implement a programmatic interface to map particular user interactions, e.g., gestures, to the input parameters of various image filtering routines, while simultaneously setting auto exposure, auto focus, and/or auto white balance or other image processing technique input parameters based on the appropriate underlying image sensor data in a way that provides a seamless, dynamic, and intuitive experience for both the user and the client application software developer.

### SUMMARY

As mentioned above, with more complex image processing routines being carried out on personal electronic devices, such as graphically-intensive image filters, e.g., image distortion filters, the number and type of inputs, as well as logical considerations regarding the orientation of the device and other factors may become too complex for client software applications to readily interpret and/or process correctly. Additionally, if the image that is currently being displayed on the device has been distorted via the application of an image filter, when a user indicates a location in the distorted image to base the setting of auto exposure, auto focus, and/or auto white balancing parameters upon, additional processing must be performed to ensure that the auto exposure, auto focus, and/or auto white balancing parameters are being set based on the correct underlying captured sensor data.

Image filters may be categorized by their input parameters. For example, circular filters, i.e., image filters with distortions or other effects centered over a particular circular-shaped region of the image, may need input parameters of “input center” and “radius.” Thus, when a client application wants to call a particular circular filter, it may query the filter for its input parameters and then pass the appropriate values retrieved from user input (e.g. gestures) and/or device input (e.g., orientation information) to a gesture translation layer, which may then map the user and device input information to the actual input parameters expected by the image filter itself. In some embodiments, the user and device input may be mapped to a value that is limited to a predetermined range, wherein the predetermined range is based on the input parameter. Therefore, the client application doesn't need to handle logical operations to be performed by the gesture translation layer or know exactly what will be done with those values by the underlying image filter. It merely needs to know that a particular filter's input parameters are, e.g., “input center” and “radius,” and then pass the relevant information along to the gesture translation layer, which will in turn give the image filtering routines the values that are needed to filter the image as indicated by the user.

With image filters having an “input center” input parameter, such as the exemplary circular filters described above, simultaneously determining the correct portions of the underlying image data to base auto exposure, auto focus, and/or auto white balance determinations upon may be quite trivial. If there are no location-based distortions between the real-world scene being photographed, i.e., the data captured by the image sensor, and what is being displayed on the personal electronic device's display, then the auto exposure, auto focus, and/or auto white balancing parameters may be set as they would be for a non-filtered image. For example, the user's tap location may be set to be the “input center” to the image filter as well as the center of an auto exposure and/or auto focus rectangle over the image sensor data upon which the setting of the auto exposure and/or focus parameters may be based. In some embodiments, the location of the auto exposure and/or auto focus rectangle may seamlessly track the location of the “input center,” e.g., as the user drags his or her finger around the touch screen display of the device. In such embodiments, it may also be advantageous to slowly change between determined auto exposure and/or auto focus parameter settings so as to avoid any visually jarring effects on the device's display as the user rapidly moves his or her finger around the touch screen display of the device.

However, if there are location-based distortions between the real-world scene being photographed and what is being displayed on the personal electronic device's display, e.g., the image being displayed on the electronic device's display is stretched, shrunk, flipped, mirrored, moved, rotated, and/or location-distorted in any other way, then the appropriate portions of the underlying image sensor data to base the setting of auto exposure and/or auto focus parameters upon may need to be determined by the device due to the fact that a user's touch point on the display will not have a one-to-one correspondence with the underlying image sensor data. For example, if an image filter has the effect of “shrinking” the image underneath the user's tap point location by a factor of 2×, then the auto exposure and/or auto focus rectangle over the image sensor data upon which the setting of the camera's auto exposure and/or focus parameters are based may need to be adjusted so that it includes the underlying image sensor data actually corresponding to the “unfiltered” portion of the image indicated by the user. With the example of the 2× shrinking filter described above, if the auto exposure and/or auto focus rectangle is normally centered over the tap location and has dimensions of 80 pixels×80 pixels in display space, then, after applying the “inverse” of the 2× shrinking filter, the device would determine that the auto exposure and/or auto focus rectangle should actually be based upon the corresponding 160 pixel×160 pixel region in the underlying image sensor data. In other words, the inverse of the applied image filter may first need to be applied so that the user's input location may be translated into the unfiltered portion of the image that the auto exposure and/or auto focus parameters should be based upon. In some such embodiments, users may be able to indicate auto exposure and/or auto focus parameters while simultaneously indicating input parameters to a variety of graphically intensive image filters.

Thus, in one embodiment described herein, an image processing method is disclosed comprising: applying an image filter to an unfiltered image to generate a first filtered image at an electronic device; receiving input indicative of a location in the first filtered image from one or more sensors in communication with the electronic device; associating an input parameter for a first image processing technique with the received input; translating the received input from a location in the first filtered image to a corresponding location in the unfiltered image; assigning a value to the input parameter based on the translated received input; applying the first image processing technique to generate a second filtered image, the input parameter having the assigned value; and storing the second filtered image in a memory.

in another embodiment described herein, an image processing method is disclosed comprising: receiving, at an electronic device, a selection of a first filter to apply to an unfiltered image; applying the first filter to the unfiltered image to generate a first filtered image; receiving input indicative of a location in the first filtered image from one or more sensors in communication with the electronic device; associating a first input parameter for the first filter with the received input; assigning a first value to the first input parameter based on the received input; associating a second input parameter for a first image processing technique with the received input; translating the received input from the location in the first filtered image to a corresponding location in the unfiltered image; assigning a second value to the second input parameter based on the translated received input; applying the first filter and the first image processing technique to generate a second filtered image, the first input parameter having the first assigned value and the second input parameter having the second assigned value; and storing the second filtered image in a memory.

In some scenarios, rather than utilizing the entirety of the captured image sensor data in the determination of auto exposure, auto focus, and/or auto white balance parameters, the device may instead determine only the relevant portions of the image sensor data that are needed in order to apply the selected image filter and/or image processing technique. For example, if a filter has characteristics such that certain portions of the captured image data are no longer visible on the display after the filter has been applied to the image, then there is no need for such non-visible portions to influence the determination of auto exposure, auto focus, and/or auto white balance parameters. Once such relevant portions of the image sensor data have been determined, their locations may be updated based on incoming user input to the device, such as a user's indication of a new “input center” to the selected image filter. Further efficiencies may be gained from both processing and power consumption standpoints for certain image filters by directing the image sensor to only capture the relevant portions of the image.

Thus, in one embodiment described herein, an image processing method is disclosed comprising: applying an image filter to an unfiltered image to generate a first filtered image at an electronic device; receiving input indicative of a location in the first filtered image from one or more sensors in communication with the electronic device; associating an input parameter for a first image processing technique with the received input; translating the received input from a location in the first filtered image to a corresponding location in the unfiltered image; determining a relevant portion of the unfiltered image based on a characteristic of the image filter; assigning a value to the input parameter based on the translated received input; applying the first image processing technique based on the determined relevant portion of the unfiltered image to generate a second filtered image, the input parameter having the assigned value; and storing the second filtered image in a memory.

Gesture-based configuration for image filter and image processing technique input parameters in accordance with the various embodiments described herein may be implemented directly by a device's hardware and/or software, thus making these intuitive image filtering and processing techniques readily applicable to any number of electronic devices, such as mobile phones, personal data assistants (PDAs), portable music players, monitors, televisions, as well as laptop, desktop, and tablet computer systems.

### BRIEF DESCRIPTION OF THE DRAWINGS

FIG. 1 illustrates a typical outdoor scene with a human subject, in accordance with one embodiment.

FIG. 2 illustrates a typical outdoor scene with a human subject as viewed on a camera device's preview screen, in accordance with one embodiment.

FIG. 3 illustrates a user interacting with a camera device via a touch gesture, in accordance with one embodiment.

FIG. 4 illustrates a user tap point and a typical exposure metering region on a touch screen of a camera device, in accordance with one embodiment.

FIG. 5A and FIG. 5B illustrate an exposure metering region that has been translated based on an applied image filter, in accordance with one embodiment.

FIG. 6 illustrates a scene with a human subject as captured by a front-facing camera of a camera device, in accordance with one embodiment.

FIG. 7 illustrates the translation of a gesture from touch screen space to image sensor space, in accordance with one embodiment.

FIG. 8 illustrates a user tap point and corresponding relevant image portion on a touch screen of a camera device, in accordance with one embodiment.

FIG. 9 illustrates a light tunnel image filter effect based on a user tap point on a touch screen of a camera device, in accordance with one embodiment.

FIG. 10 illustrates, in flowchart form, one embodiment of a process for performing gesture-based configuration of image filter and image processing routine input parameters.

FIG. 11 illustrates, in flowchart form, one embodiment of a process for translating user input in a distorted image into image processing routine input parameters.

FIG. 12 illustrates, in flowchart form, one embodiment of a process for basing image processing decisions on only the relevant portions of the underlying image sensor data.

FIG. 13 illustrates a simplified functional block diagram of a device possessing a display, in accordance with one embodiment.

### DETAILED DESCRIPTION

This disclosure pertains to apparatuses, methods, and computer readable medium for mapping particular user interactions, e.g., gestures, to the input parameters of various image filters, while simultaneously setting auto exposure, auto focus, auto white balance, and/or other image processing technique input parameters based on the appropriate underlying image sensor data in a way that provides a seamless, dynamic, and intuitive experience for both the user and the client application software developer. Such techniques may handle the processing of image filters applying “location-based distortions,” i.e., those image filters that translate the location and/or size of objects in the captured image data to different locations and/or sizes on a camera device's display, as well as those image filters that do not apply location-based distortions to the captured image data. Additionally, techniques are provided for increasing the performance and efficiency of various image processing systems when employed in conjunction with image filters that do not require all of an image sensor's captured image data to produce theft desired image filtering effects.

The techniques disclosed herein are applicable to any number of electronic devices with optical sensors: such as digital cameras, digital video cameras, mobile phones, personal data assistants (PDAs), portable music players, monitors, televisions, and, of course, desktop, laptop, and tablet computer displays.

In the interest of clarity, not all features of an actual implementation are described in this specification. It will of course be appreciated that in the development of any such actual implementation (as in any development project), numerous decisions must be made to achieve the developers' specific goals (e.g., compliance with system- and business-related constraints), and that these goals will vary from one implementation to another. It will be appreciated that such development effort might be complex and time-consuming, but would nevertheless be a routine undertaking for those of ordinary skill having the benefit of this disclosure.

In the following description, for purposes of explanation, numerous specific details are set forth in order to provide a thorough understanding of the inventive concept. As part of the description, some structures and devices may be shown in block diagram form in order to avoid obscuring the invention. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

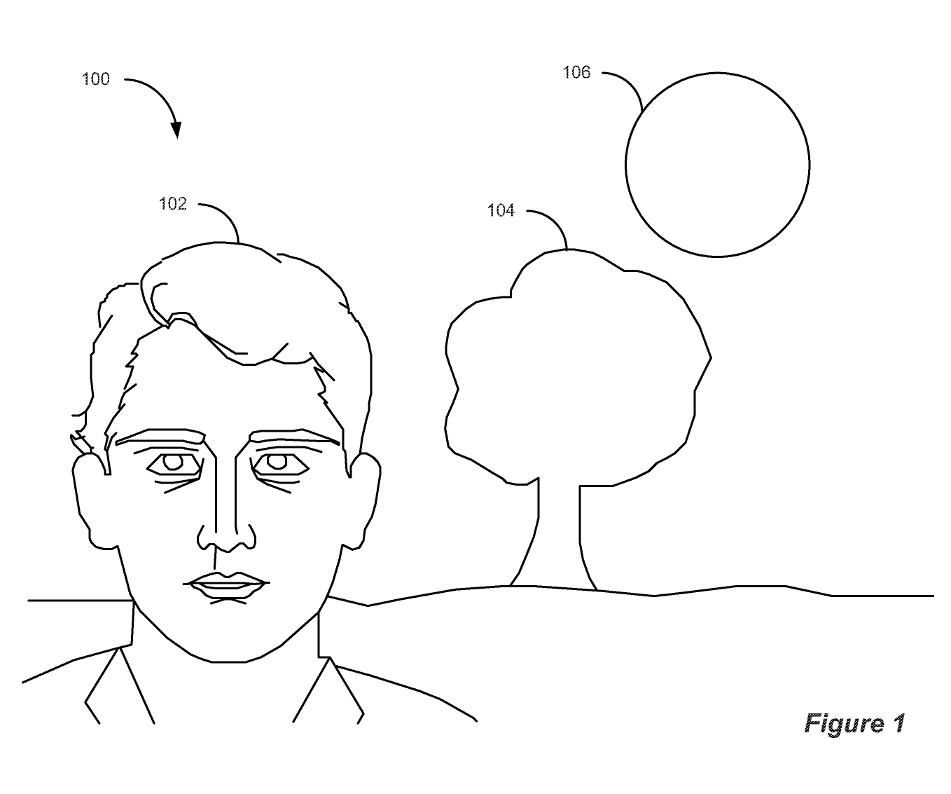

Referring now to FIG. 1, a typical outdoor scene 100 with a human subject 102 is shown, in accordance with one embodiment. The scene 100 also includes the Sun 106 and a natural object, tree 104. Scene 100 will be used in the subsequent figures as an exemplary scene to illustrate the various image processing techniques described herein.

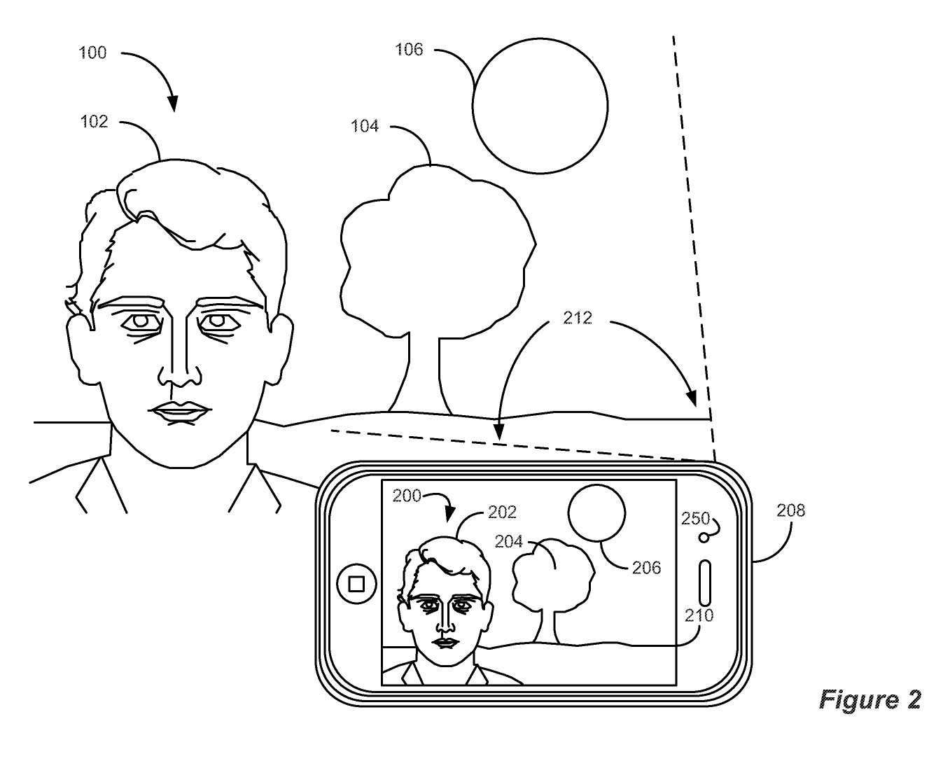

Referring now to FIG. 2, a typical outdoor scene 200 with a human subject 202 as viewed on a camera device 208's preview screen 210 is shown, in accordance with one embodiment. The dashed lines 212 indicate the viewing angle of the camera (not shown) on the reverse side of camera device 208. Camera device 208 may also possess a second camera, such as front-facing camera 250. Other numbers and positions of cameras on camera device 208 are also possible. As mentioned previously, although camera device 208 is shown here as a mobile phone, the teachings presented herein are equally applicable to any electronic device possessing a camera, such as, but not limited to: digital video cameras, personal data assistants (PDAs), portable music players, laptop/desktop/tablet computers, or conventional digital cameras. Each object in the scene 100 has a corresponding representation in the scene 200 as viewed on a camera device 208's preview screen 210. For example, human subject 102 is represented as object 202, tree 104 is represented as object 204, and Sun 106 is represented as object 206.

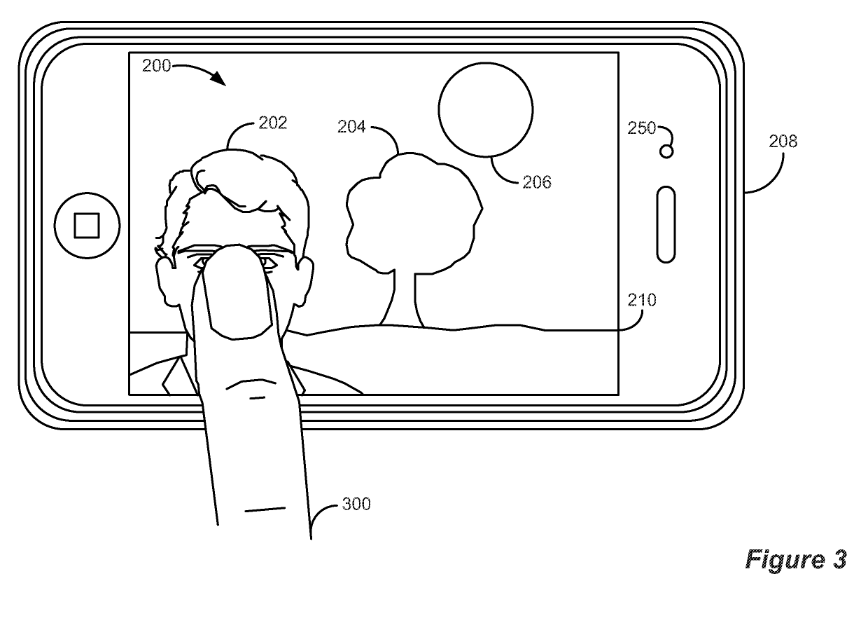

Referring now to FIG. 3, a user 300 interacting with a camera device 208 via an exemplary touch gesture is shown, in accordance with one embodiment. The preview screen 210 of camera device 208 may be, for example, a touch screen. The touch-sensitive touch screen 210 provides an input interface and an output interface between the device 208 and a user 300. The touch screen 210 displays visual output to the user. The visual output may include graphics, text, icons, pictures, video, and any combination thereof.

A touch screen such as touch screen 210 has a touch-sensitive surface, sensor or set of sensors that accepts input from the user based on haptic and/or tactile contact. The touch screen 210 detects contact (and any movement or breaking of the contact) on the touch screen 210 and converts the detected contact into interaction with user-interface objects (e.g., one or more soft keys, icons, web pages, images or portions of images) that are displayed on the touch screen. In an exemplary embodiment, a point of contact between a touch screen 210 and the user corresponds to a finger of the user 300.

The touch screen 210 may use LCD (liquid crystal display) technology, or LPD (light emitting polymer display) technology, although other display technologies may be used in other embodiments. The touch screen 210 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 210.

The touch screen 210 may have a resolution in excess of 300 dots per inch (dpi). In an exemplary embodiment, the touch screen has a resolution of approximately 325 dpi. The user 300 may make contact with the touch screen 210 using any suitable object or appendage, such as a stylus, a finger, and so forth. In some embodiments, the user interface is designed to work primarily with finger-based contacts and gestures, which typically have larger areas of contact on the touch screen than stylus-based input. In some embodiments, the device translates the rough finger-based gesture input into a precise pointer/cursor coordinate position or command for performing the actions desired by the user 300.

As used herein, a gesture is a motion of the object/appendage making contact with the touch screen display surface. One or more fingers may be used to perform two-dimensional or three-dimensional operations on one or more graphical objects presented on preview screen 210, including but not limited to: magnifying, zooming, expanding, minimizing, resizing, rotating, sliding, opening, closing, focusing, flipping, reordering, activating, deactivating and any other operation that can be performed on a graphical object. In some embodiments, the gestures initiate operations that are related to the gesture in an intuitive manner. For example, a user can place an index finger and thumb on the sides, edges or corners of a graphical object and perform a pinching or anti-pinching gesture by moving the index finger and thumb together or apart, respectively. The operation initiated by such a gesture results in the dimensions of the graphical object changing. In some embodiments, a pinching gesture will cause the size of the graphical object to decrease in the dimension being pinched. In some embodiments, a pinching gesture will cause the size of the graphical object to decrease proportionally in all dimensions. In some embodiments, an anti-pinching or de-pinching movement will cause the size of the graphical object to increase in the dimension being anti-pinched. In other embodiments, an anti-pinching or de-pinching movement will cause the size of a graphical object to increase in all dimensions (e.g., enlarging proportionally in the x and y dimensions).

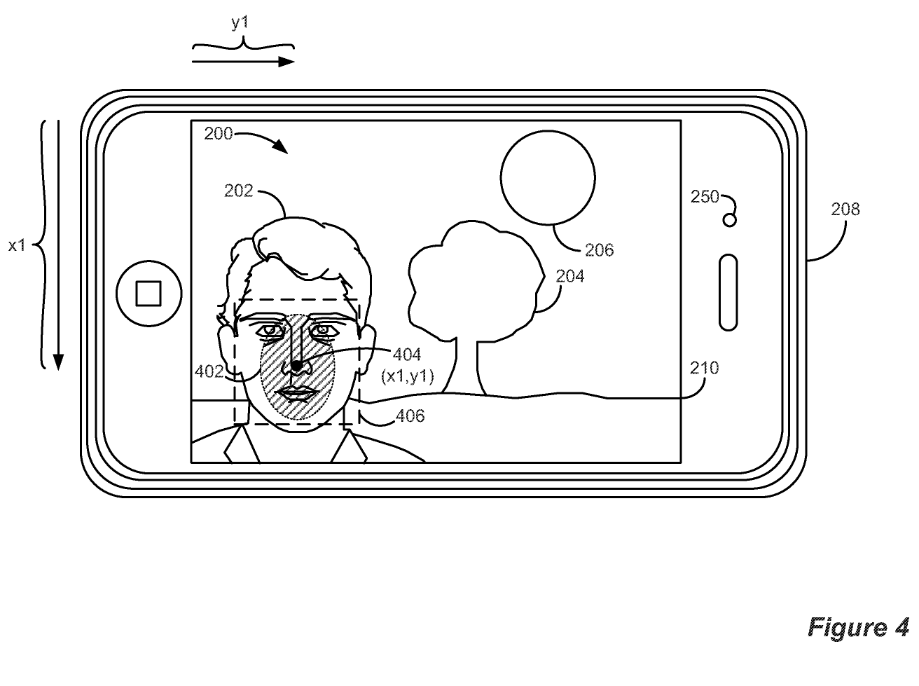

Referring now to FIG. 4, a user tap point 402 and an exposure metering region 406 on a touch screen 210 of a camera device 208 is shown, in accordance with one embodiment. The location of tap point 402 is represented by an oval shaded with diagonal lines. As mentioned above, in some embodiments, the device translates finger-based tap points into a precise pointer/cursor coordinate position, represented in FIG. 4 as point 404 with coordinates x1 and y1. As shown in FIG. 4, the x-coordinates of the device's display correspond to the shorter dimension of the display, and the y-coordinates correspond to the longer dimension of the display.

In auto exposure algorithms according to some embodiments, an exposure metering region is inset over the image frame, e.g., the exposure metering region may be a rectangle with dimensions equal to approximately 75% of the camera's display dimensions, and the camera's exposure parameters may be driven such that the average brightness of the pixels within exposure metering rectangle 406 are equal or nearly equal to an 18% gray value. For example, with 8-bit luminance (i.e., brightness) values, the maximum luminance value is 2⁸−1, or 255, and, thus, an 18% gray value would be 255*0.18, or approximately 46. If the average luminance of the scene is brighter than the optimum 18% gray value by more than a threshold value, the camera could, e.g., decrease the exposure time, t, whereas, if the scene were darker than the optimum 18% gray value by more than a threshold value, the camera could, e.g., increase the exposure time, t.

A simple, inset rectangle-based auto exposure algorithm, such as that explained above may work satisfactorily for some scene compositions, but may lead to undesirable photos in other types of scenes, e.g., if there is a human subject in the foreground of a brightly-lit outdoor scene, as is shown in FIG. 4. Thus, in other embodiments, the exposure metering region may more preferably be weighted towards a smaller rectangle of predetermined size based on, e.g., a location in the image indicated by a user or a detected face within the image. As shown in FIG. 4, exposure metering region 406 is a rectangle whose location is centered on point 404. The dimensions of exposure metering region 406 may be predetermined or may be based on some other empirical criteria, e.g., the size of a detected face near the point 404, or a percentage of the dimensions of the display. Once the location and dimensions of exposure metering region 406 are determined, any number of ell-known auto exposure algorithms may be employed to drive the camera's exposure parameters. Such algorithms may more heavily weight the values inside exposure metering region 406—or disregard values outside exposure metering region 406 altogether—in making its auto exposure determinations. Many variants of auto exposure algorithms are well known in the art, and thus are not described here in great detail.

Likewise, auto focusing routines may use the pixels within the determined exposure metering region to drive the setting of the camera's focus. Such auto exposure and auto focus routines may operate under the assumption that an area in the image indicated by the user, e.g., via a tap gesture, is an area of interest in the image, and thus an appropriate location in the image to base the focus and/or exposure settings for the camera on.

In some embodiments, the user-input gestures to device 208 may also be used to drive the setting of input parameters of various image filters, e.g., image distortion filters. The above functionality can be realized with an input parameter gesture mapping process. The process begins by detecting N contacts on the display surface 210. When N contacts are detected, information such as the location, duration, size, and rotation of each of the N contacts is collected by the device. The user is then allowed to adjust the input parameters by making or modifying a gesture at or near the point of contact. If motion is detected, the input parameters may be adjusted based on the motion. For example, the central point of an exemplary image distortion filter may be animated to simulate the motion of the user's finger and to indicate to the user that the input parameter, i.e., the central point of the image distortion filter, is being adjusted in accordance with the motion of the user's finger.

While the parameter adjustment processes described above includes a number of operations that appear to occur in a specific order, it should be apparent that these processes can include more or fewer steps or operations, which can be executed serially or in parallel (e.g., using parallel processors or a multi-threading environment).

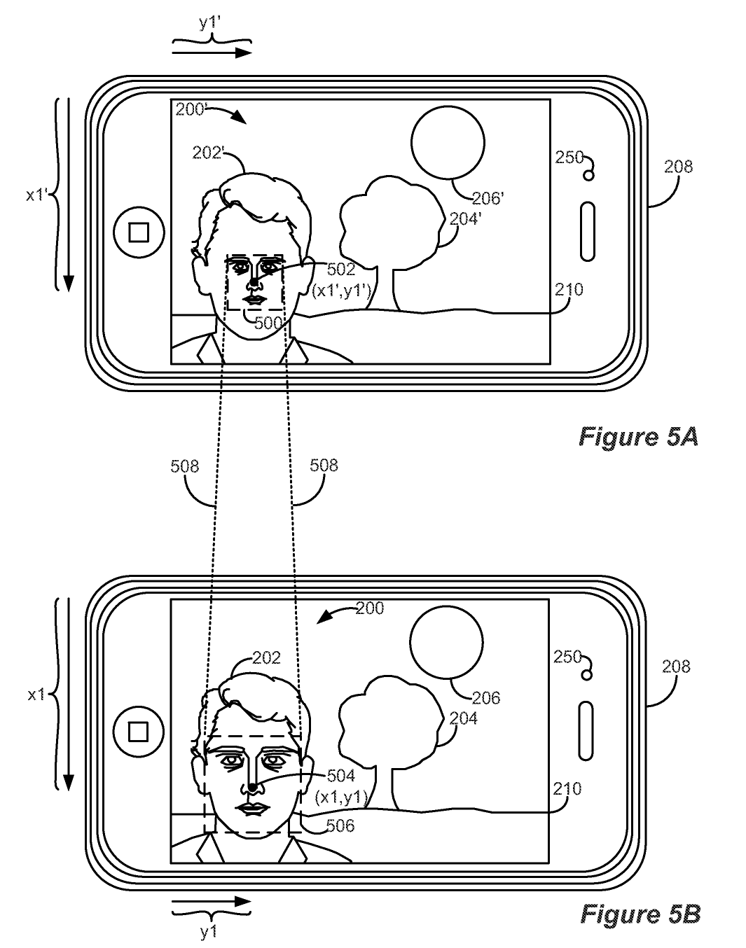

Referring now to FIG. 5A, a distorted version 200′ of scene 200 is shown as displayed on the preview screen 210 of camera device 208. Distorted scene 200′ includes distorted versions of the human subject 202′, tree 204′ and Sun 206′. In the example of FIG. 5A, a “shrink” filter distortion has been applied to the scene 200 that shrinks a portion of the image around a tap location as indicated by the user. Point 502 having coordinates (x1′, y1′) in distorted, i.e., display, space serves as a representation of the user's tap point on the device's display. The exemplary shrinking image distortion filter shown in FIG. 5A uses point 502 as the center of its applied effect, in this case, shrinking the image data in a predetermined area around point 502. In this exemplary embodiment of a shrinking distortion filter, the tap point 502 is in the center of subject 202's face, resulting in subject 202's facial features being shrunken by an amount as determined by the shrinking image filter. As shown in FIG. 5A, an exemplary exposure metering region 500 in distorted, i.e., display, space was calculated based on the location of tap point 502 and preferred exposure metering region dimensions. However, the pixels within exposure metering region 500 actually correspond to a different set of pixels in the underlying image sensor data, thus an inverse transformation will need to be performed on the determined location of the exposure metering region 500 in display space to ensure that the correct underlying image data in sensor space is used in the determination of auto exposure parameters, as will be seen below.

Referring now to FIG. 5B, the undistorted version of scene 200 is shown as displayed on the preview screen 210 of camera device 208, FIG. 5B corresponds to the undistorted image sensor data captured directly by the camera's image sensor. By applying the inverse of the image distortion filter applied in FIG. 5A, the location of the pixels corresponding to exposure metering region 500 may be located in the underlying image sensor data. In the case of FIG. 5A, a “shrink” filter distortion has been applied, so a corresponding inverse “expansion” distortion can be applied to the dimensions of exposure metering region 500 to locate exposure metering region 506 in the image sensor data represented in FIG. 5B. In the example of FIGS. 5A and 5B, there is no translation of the location of the tap point performed by the shrink filter, that is, x1′=x1 and y1′=y1, so the location of point 502 in display space corresponds directly to the location of point 504 in sensor space. With other image filters, however, there may be translations, size distortions, both, or neither between sensor space and display space. As can be seen by following trace lines 508 from FIG. 5A down to FIG. 5B, the exposure metering region 500 in display space corresponds to the same subject matter in the image as exposure metering region 506 in sensor space. Specifically, the exposure metering regions 500/506 each stretch from the subject 202's left eyebrow to right eyebrow in width, and from above subject 202's eyebrows to below subject 202's lips in height. As may also be seen, the exposure metering region in underlying image sensor data 506 is approximately twice the size of the determined exposure metering region in display space 500. The important resulting consequence of this translation is that the correct portion of captured image data will now be used to drive the auto exposure, auto focus, auto white balance, and/or other image processing systems of camera 208.

To implement changes in auto exposure and other image processing parameters in a visually pleasing way, the techniques described herein may “animate” between the determined changes in parameter value, that is, the device may cause the parameters to slowly drift from an old value to a new value, rather than snap immediately to the newly determined parameter values. The rate at which the parameter values change may be predetermined or set by the user. In some embodiments, the camera device may receive video data, i.e., a stream of unfiltered images captured by an image sensor of the camera device. In such embodiments, the device may adjust the parameter values incrementally towards their new values over the course of a determined number of consecutively captured unfiltered images from the video stream. For example, the device may adjust parameter values towards their new values by 10% with each subsequently captured image frame from the video stream, thus resulting in the changes in parameter values being implemented smoothly over the course of ten captured image frames (assuming no new parameter values were calculated during the transition).

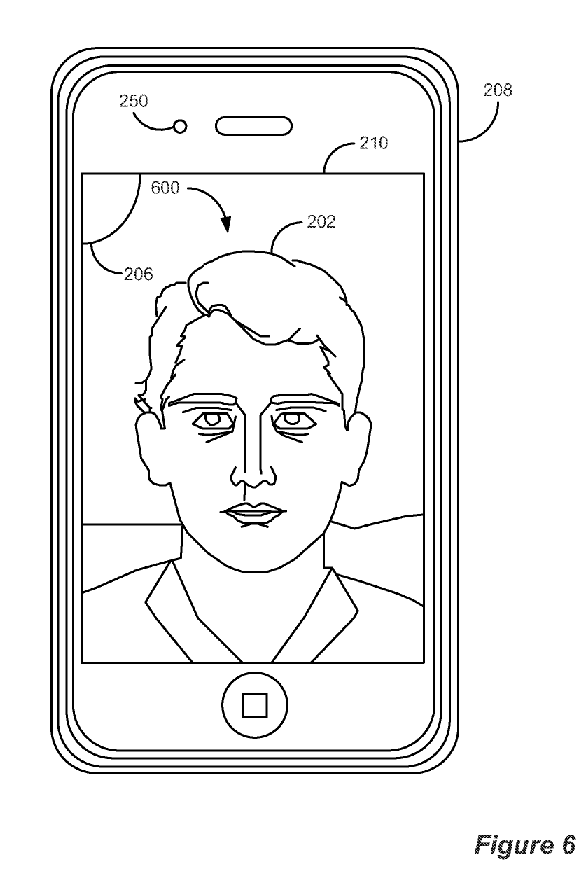

Referring now to FIG. 6, a scene 600 with a human subject 202 as captured by a front-facing camera 250 of a camera device 208 is shown, in accordance with another embodiment. Because scene 600 was captured by front-facing camera 250, human subject 202's representation on display 210 is a mirrored version of his “real world” location. That is, the image displayed is horizontally flipped compared to the image the sensor receives. Mirroring is probably the simplest and easiest to understand of translations between sensor space and display space, thus it is used as an explanatory example herein. The same translation techniques described herein may be applied to any number of complex translations between sensor space and display space by using appropriate mathematics based on the characteristics of the image filter or filters being applied to create the translation to display space.

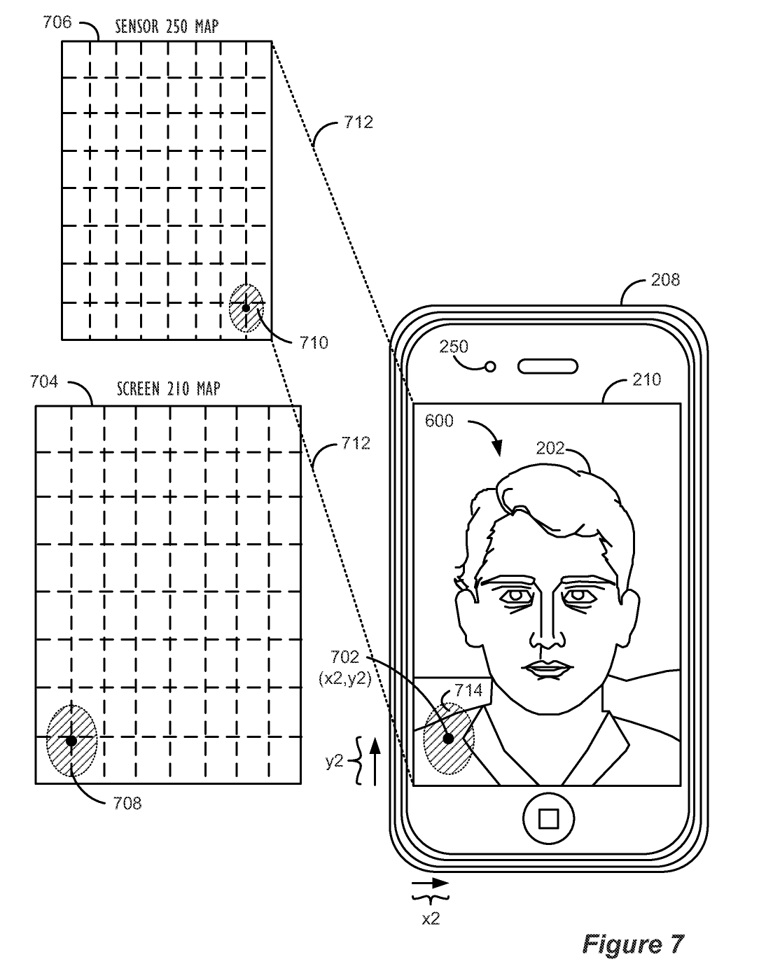

Referring now to FIG. 7, the translation of a gesture from “display space” to “sensor space” is shown in greater detail, in accordance with one embodiment. With certain gestures and image filters, the device may need to account for whether or not the image being displayed on the device's display is actually a mirrored or otherwise translated image of the “real world,” e.g., the image being displayed on the device is often mirrored when a front-facing camera such as front-facing camera 250 is being used to drive the device's display. In instances where the image being displayed on the device's display is actually a translated image of the “real world,” it may become necessary for the gesture-based configuration techniques described herein to translate the location of a user's gesture input from “display space” to “sensor space” so that the image filtering effect and/or image processing techniques are properly applied to the portion(s) of the captured image data indicated by the user. As shown in FIG. 7, user 202 is holding the device 208 and pointing it back at himself to capture scene 600 utilizing front-facing camera 250. As shown in scene 700, the user 202 has centered himself in the scene 600, as is common behavior in videoconferencing or other self-facing camera applications.

For the sake of illustration, assume that the user 202 has selected an image filter that he would like to be applied to scene 600, and that his selected image filter requires the coordinates of an input point as its only input parameter. As described above, the location of the user's touch point 714, may be defined by point 702 having coordinates x2 and y2. The “display space” in the example of FIG. 7 is illustrated by screen 210 map (704). As can be understood by comparing the location of touch point 714 on touch screen 210 and touch point 708, as represented in touch screen space on screen 210 map (704), a touch point on the touch screen 210 will always translate to an identical location in display space, no matter what way the device is oriented, or which of the device's camera is currently driving the device's display. For image filters and/or image processing techniques where there is a central location to the image filter's effect, an additional translation between the input point in “display space” and the input point in “sensor space” may be required before the image filter effect is applied, as is explained further below.

For example, as illustrated in FIG. 7, if the user 210 initiates a single tap gesture in the lower left corner of the touch screen 210, he is actually clicking on a part of the touch screen that corresponds to the location of his right shoulder. As may be better understood when following trace lines 712 between touch screen 210 and the sensor 250 map (706), touch point 702 in the lower left corner of touch screen 210 translates to the a touch point 710 in the equivalent location in the lower right corner of sensor 250 map (706). This is because it is actually the pixels on the right side of the image sensor that correspond to the pixels displayed on the left side of touch screen 210 when the front-facing camera 250 is driving the device's display. In other embodiments, further translations may be needed to map between touch input points indicated by the user in display space and the actual corresponding pixels in sensor space, based on the characteristics of the image filter being applied. For example, the touch input point may need to be mirrored and then rotated ninety degrees, or the touch input point may need to be rotated 180 degrees to ensure that the image filter's effect is applied to the correct corresponding image sensor data. By examining the characteristics of the image filter or filters being applied to the image, the appropriate translations may be carried out mathematically by a processor in communication with the camera device to determine the regions in image sensor space corresponding to the regions of user interaction with the device in display space. Likewise, such gesture translations may be used to ensure that auto exposure, auto focus, and/or auto white balance parameters are determined based on the appropriate underlying image sensor data.

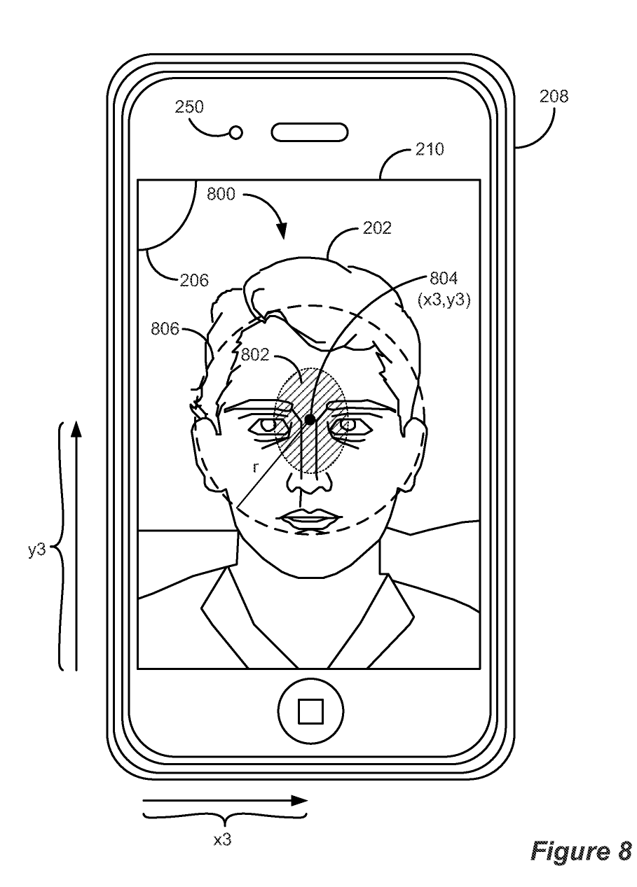

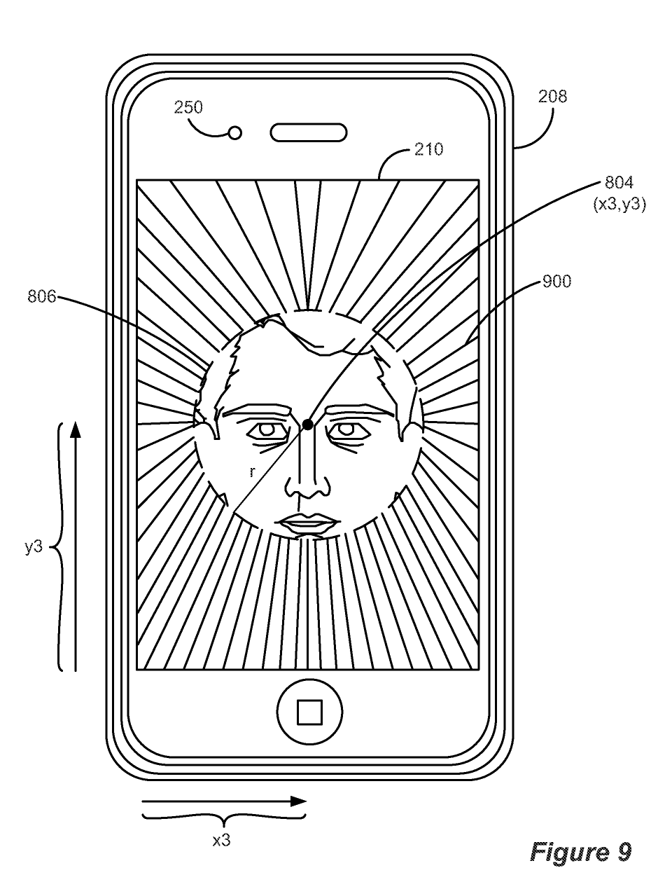

Referring now to FIG. 8, a user tap point 802 and corresponding relevant image portion 806 on a touch screen 210 of a camera device 208 are shown, in accordance with one embodiment. The device may translate finger-based tap points 802 into a precise pointer/cursor coordinate position, represented in FIG. 8 as point 804 with coordinates x3 and y3. In the example shown in FIG. 8, an exemplary “light tunnel” image filter effect will be applied to the image data. The light tunnel image filter effect may take as its inputs, e.g., “input center” and “radius.” In some embodiments, the “input center” will be set at the location of point 804, and the radius will be set to a predetermined value, r, as shown in FIG. 8. In other embodiments, the user could employ a multi-touch or other similar gesture to manually indicate the value for the radius, r. As shown in FIG. 8, the center point 804 and radius, r, define a relevant image portion 806, represented by a dashed-line circle. With the exemplary light tunnel image filter, and other similar filters, only those pixels within the relevant image portion 806 will be involved in the determining the filtered image and driving the camera device's auto exposure, auto focus, and other image processing systems, as will be seen in further detail in FIG. 9.

Referring now to FIG. 9, a light tunnel image filter effect 900 based on a user tap point on a touch screen 210 of a camera device 208 is shown, in accordance with one embodiment. As mentioned above, only those pixels within the relevant image portion 806 are involved in the determining the filtered image and driving the camera device's auto exposure, auto focus, and other image processing systems. Specifically, the light tunnel image filter effect makes it look as though the area of the image within relevant portion 806 is traveling at a very high velocity down a tunnel, leaving a trail of light behind it. As such, the pixels in the captured image outside of relevant portion 806 do not have to be relied upon for either the implementation of the image filter effect or the calculation of the auto exposure, auto focus, and/or auto white balance parameters. By optionally instructing the image sensor not to capture information outside of the relevant image portion 806, both processing and power consumption efficiency may be increased. Each image filter will have to specify its own “relevant image portion” and the manner by which the relevant image portion may be defined by various user inputs so that the techniques described herein may disregard the appropriate portions of the image when determining either the image filter effect or setting auto exposure, auto focus, and/or auto white balance parameters. For other types of image filter effects, e.g., radial effects like a “Twirl” filter, the configuration process may map a rectangular box on the display to a non-rectangular shape in sensor space. Since camera hardware typically requires an aligned rectangle for AE/AF/AWB image processing techniques, such techniques may then be driven by pixels inside the bounding box that encompasses this distorted-shaped in sensor space.

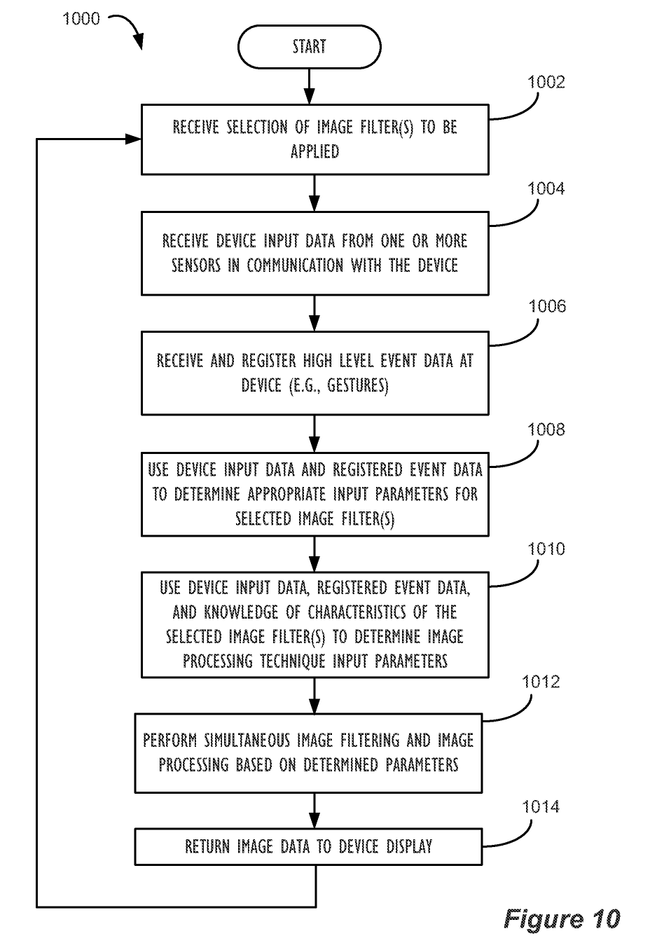

Referring now to FIG. 10, one embodiment of a process 1000 for performing gesture-based configuration of image filter and image processing routine input parameters is shown in flowchart form. First, the process receives the selection of image filter(s) to be applied (Step 1002). Next, the process receives device input data from one or more sensors disposed within or otherwise in communication with the device (e.g., image sensor, orientation sensor, accelerometer, GPS, gyrometer) (Step 1004). Next, the process receives and registers high level event data at the device (e.g., gestures) (Step 1006). After this, the process may then use the device input data and registered event data to determine the appropriate input parameters for the selected image filter(s) (Step 1008). Next, the process uses device input data and registered event data, combined with knowledge of the characteristics of the selected image filters to determine auto exposure, auto focus, auto white balance and/or other image processing technique input parameters for the camera (Step 1010). Finally, the process performs simultaneous image filtering and auto exposure, auto focus, auto white balance and/or other image processing techniques based on the determined parameters (Step 1012) and returns the processed image data to the device's display (Step 1014). In some embodiments, the processed image data may be returned directly to the client application for additional processing before being displayed on the device's display. In other embodiments, the image filter may be applied to a previously stored image. In still other embodiments, a specified gesture, e.g., shaking the device or quickly double tapping the touch screen, may serve as an indication that the user wishes to reset the image filters to their default parameters.

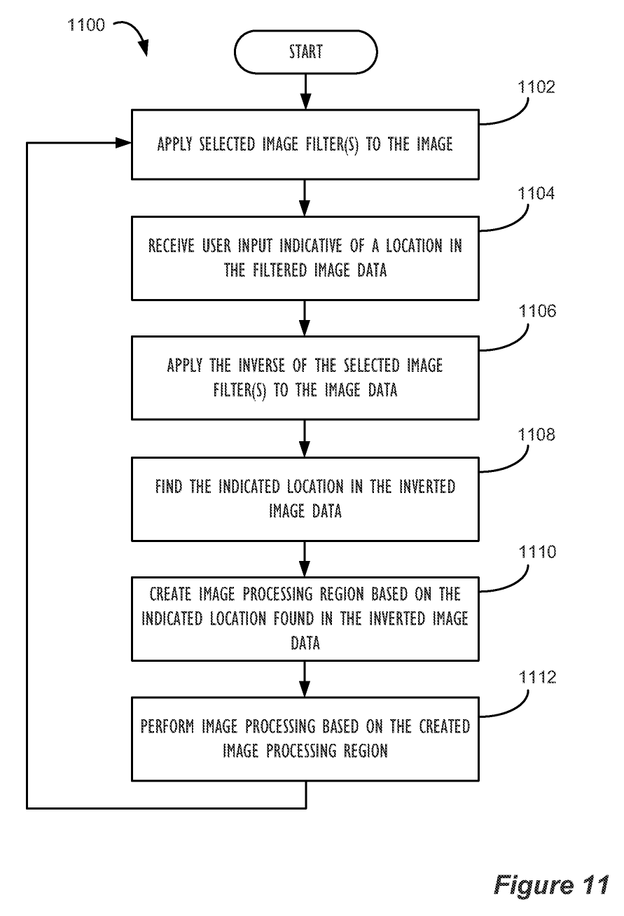

Referring now to FIG. 11, one embodiment of a process 1100 for translating user input in a distorted image into image processing routine input parameters is shown in flowchart form. First, the process applies any selected image filters to the image (Step 1102). Next, the process may receive user input indicative of a location in the filtered image data (Step 1104). Once the user input has been received, the process may apply the inverse of the selected image filter(s) to the image data (Step 1106) to attempt to determine the location in the unfiltered image data of the user's indicated location (Step 1108). Once the appropriate region is located in the unfiltered image data, i.e., in the sensor image data, the process may create an auto exposure, auto focus and/or other image processing region based on the indicated location found in the inverted image data (Step 1110). Such a created region may serve as, e.g., an exposure metering region or auto focus region over the appropriate area of interest in the image. Next, the process may perform the image processing technique based on the created region (Step 1112). In some embodiments of auto exposure algorithms, the determination of auto exposure parameters may be based entirely on the image data within the auto exposure box, whereas, in other embodiments of auto exposure algorithms, the image data within the auto exposure box may merely be weighted more heavily than the rest of the image data. With the image processing techniques applied based on the corresponding data in the properly inverted filtered image data, the process may then return to Step 1102 to apply the selected image filter(s) to the image based on the received user input and the newly-set image processing systems.

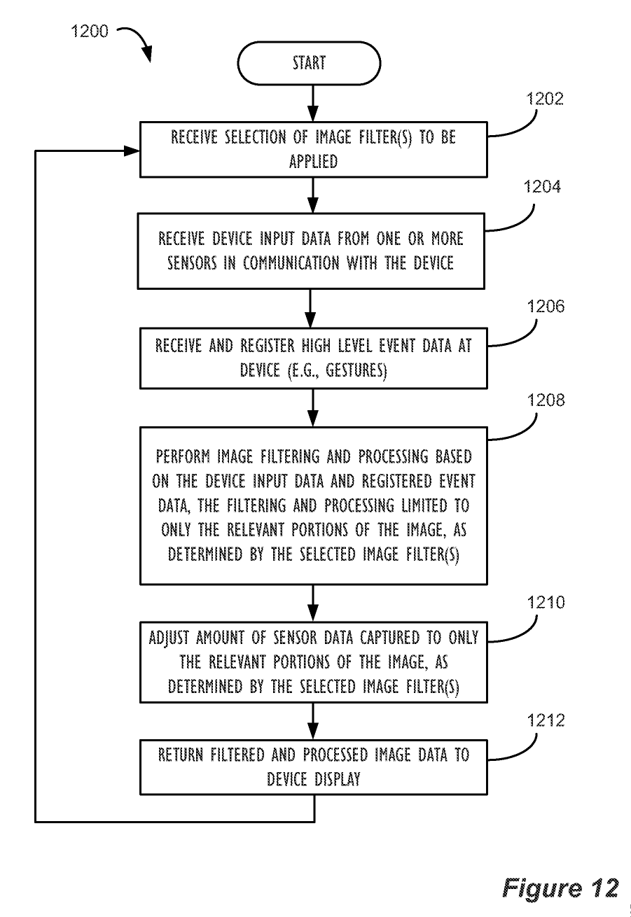

Referring now to FIG. 12, one embodiment of a process for basing image processing decisions on only the relevant portions of the underlying image sensor data is shown in flowchart form. First, the process receives the selection of image filter(s) to be applied (Step 1202). Next, the process receives device input data from one or more sensors disposed within or otherwise in communication with the device (Step 1204). Next, the process receives and registers high level event data at the device (e.g., gestures) (Step 1206). After this, the process uses device input data and registered event data to perform image filtering and/or image processing, e.g., auto exposure/auto focusing, wherein the filtering and processing are limited to only the relevant portions of the image, as determined by the characteristics of the selected image filters) (Step 1208). To achieve additional efficiencies, the process may then optionally adjust the amount of sensor data captured to only the relevant portions of the image, as determined by the characteristics of the selected image filter(s) (Step 1210) before returning the filtered and processed image data to the device's display (Step 1212).

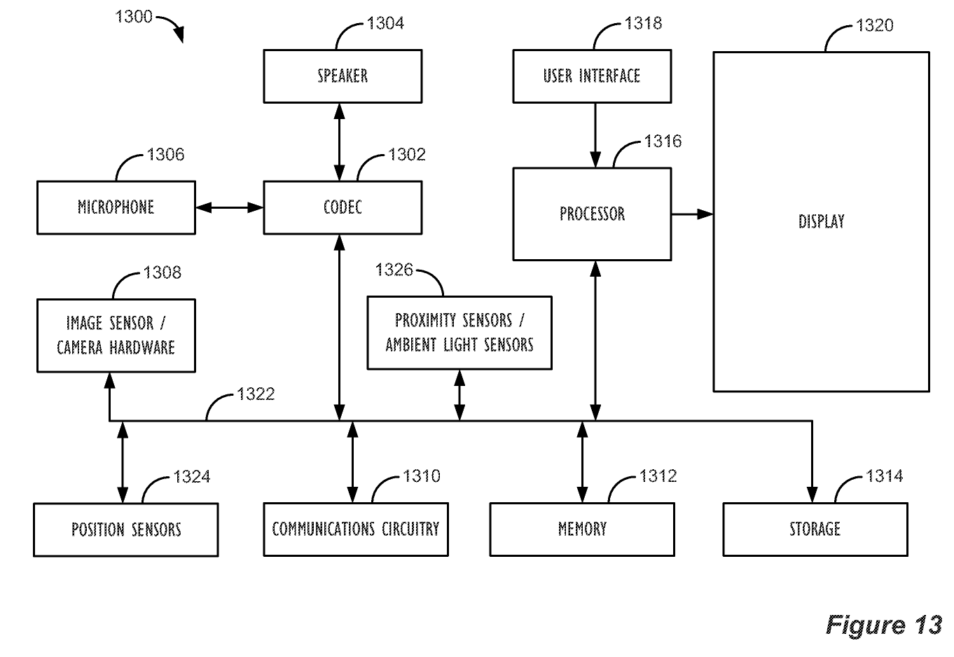

Referring now to FIG. 13, a simplified functional block diagram of a representative electronic device possessing a display 1300 according to an illustrative embodiment, e.g., camera device 208, is shown. The electronic device 1300 may include a processor 1316, display 1320, proximity sensors/ambient light sensors 1326, microphone 1306, audio/video codecs 1302, speaker 1304, communications circuitry 1310, position sensors 1324, image sensor with associated camera hardware 1308, user interface 1318, memory 1312, storage device 1314, and communications bus 1322. Processor 1316 may be any suitable programmable control device and may control the operation of many functions, such as the mapping of gestures to image filter and image processing technique input parameters, as well as other functions performed by electronic device 1300. Processor 1316 may drive display 1320 and may receive user inputs from the user interface 1318. An embedded processor, such a Cortex® A8 with the ARM® v7-A architecture, provides a versatile and robust programmable control device that may be utilized for carrying out the disclosed techniques. (CORTEX and ARM® are registered trademarks of the ARM Limited Company of the United Kingdom.)

Storage device 1314 may store media (e.g., image and video files), software (e.g., for implementing various functions on device 1300), preference information, device profile information, and any other suitable data. Storage device 1314 may include one more storage mediums, including for example, a hard-drive, permanent memory such as ROM, semi-permanent memory such as RAM, or cache.

Memory 1312 may include one or more different types of memory which may be used for performing device functions. For example, memory 1312 may include cache, ROM, and/or RAM. Communications bus 1322 may provide a data transfer path for transferring data to, from, or between at least storage device 1314, memory 1312, and processor 1316. User interface 1318 may allow a user to interact with the electronic device 1300. For example, the user input device 1318 can take a variety of forms, such as a button, keypad, dial, a click wheel, or a touch screen.

In one embodiment, the personal electronic device 1300 may be a electronic device capable of processing and displaying media such as image and video foes. For example, the personal electronic device 1300 may be a device such as such a mobile phone, personal data assistant (PDA), portable music player, monitor, television, laptop, desktop, and tablet computer, or other suitable personal device.

The foregoing description of preferred and other embodiments is not intended to limit or restrict the scope or applicability of the inventive concepts conceived of by the Applicants. As one example, although the present disclosure focused on touch screen display screens, it will be appreciated that the teachings of the present disclosure can be applied to other implementations, such as stylus-operated display screens. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. An image processing method, comprising:
applying an image filter to an unfiltered image to generate a first filtered image at an electronic device;
receiving input indicative of a location in the first filtered image from one or more sensors in communication with the electronic device;
associating an input parameter for a first image processing technique with the received input;
translating the received input from a location in the first filtered image to a corresponding location in the unfiltered image;
assigning a value to the input parameter based on the translated received input;
applying the first image processing technique to generate a second filtered image, the input parameter having the assigned value; and
storing the second filtered image in a memory.

2. The method of claim 1, wherein the first image processing technique comprises one of: auto exposure, auto focus, and auto white balance.

3. The method of claim 1, wherein the act of receiving input indicative of a location in the first filtered image from one or more sensors in communication with the electronic device comprises receiving gesture input from an electronic device having a touch-sensitive display.

4. The method of claim 3, wherein the act of receiving gesture input comprises receiving gesture input corresponding to a single point of contact with the touch-sensitive display.

5. The method of claim 3, wherein the act of assigning a value to the input parameter comprises mapping the gesture input to a value, wherein the value is limited to a predetermined range, and wherein the predetermined range is based on the input parameter.

6. The method of claim 1, further comprising the act of displaying the second filtered image on a display.

7. The method of claim 1, wherein the act of translating the received input from a location in the first filtered image to a corresponding location in the unfiltered image comprises applying an inverse of the image filter to the location in the first filtered mage.

8. The method of claim 1, wherein the act of translating the received input from a location in the first filtered image to a corresponding location in the unfiltered image comprises determining a position and size of a region in the unfiltered image.

9. The method of claim 1, wherein the act of translating the received input from a location in the first filtered image to a corresponding location in the unfiltered image is based on a characteristic of the image filter.

10. The method of claim 1, further comprising the act of:
receiving a stream of unfiltered images captured by a camera of the electronic device,
wherein the act of assigning a value to the input parameter based on the received input comprises adjusting the input parameter incrementally towards the value over the course of a determined number of consecutively captured unfiltered images from the stream.

11. An image processing method, comprising.
receiving, at an electronic device, a selection of a first filter to apply to an unfiltered image;
applying the first filter to the unfiltered image to generate a first filtered image;
receiving input indicative of a location in the first filtered image from one or more sensors in communication with the electronic device;
associating a first input parameter for the first filter with the received input;
assigning a first value to the first input parameter based on the received input;
associating a second input parameter for a first image processing technique with the received input;
translating the received input from the location in the first filtered image to a corresponding location in the unfiltered image;
assigning a second value to the second input parameter based on the translated received input;
applying the first filter and the first image processing technique to generate a second filtered image, the first input parameter having the first assigned value and the second input parameter having the second assigned value; and
storing the second filtered image in a memory.

12. The method of claim 11, wherein the first image processing technique comprises one of: auto exposure, auto focus, and auto white balance.

13. The method of claim 11, wherein the act of receiving input indicative of a location in the first filtered image from one or more sensors in communication with the electronic device comprises receiving gesture input from an electronic device having a touch-sensitive display.

14. The method of claim 13, wherein the act of receiving gesture input comprises receiving gesture input corresponding to a single point of contact with the touch-sensitive display.

15. The method of claim 13, wherein the act of assigning a first value to the first input parameter comprises mapping the gesture input to a value, wherein the value is limited to a predetermined range, and wherein the predetermined range is based on the input parameter.

16. The method of claim 11, further comprising the act of displaying the second filtered image on a display.

17. The method of claim 11, wherein the act of assigning a first value to the first input parameter based on the received input comprises applying a first translation to the received input, wherein the first translation applied is based on the received input.

18. The method of claim 17, wherein the received input is indicative of a position on a touch-sensitive display of the electronic device.

19. The method of claim 17, wherein the electronic device comprises a plurality of cameras, and wherein the first translation applied to the received input is based on the camera used by the electronic device to capture the image.

20. The method of claim 11, wherein the act of translating the received input from a location in the first filtered image to a corresponding location in the unfiltered image comprises applying an inverse of the first filter to the location in the first filtered image.

21. The method of claim 11, wherein the act of translating the received input from a location in the first filtered image to a corresponding location in the unfiltered image comprises determining a position and size of a region in the unfiltered image.

22. The method of claim 11, wherein the act of translating the received input from a location in the first filtered image to a corresponding location in the unfiltered image is based on a characteristic of the first filter.

23. The method of claim 11, further comprising the act of:
receiving a stream of unfiltered images captured by a camera of the electronic device,
wherein the act of assigning a first value to the first input parameter based on the received input comprises adjusting the first input parameter incrementally towards the first value over the course of a determined number of consecutively captured unfiltered images from the stream.

24. The method of claim 11, further comprising the act of:
receiving a stream of unfiltered images captured by a camera of the electronic device,
wherein the act of assigning a second value to the second input parameter based on the translated received input comprises adjusting the second input parameter incrementally towards the second value over the course of a determined number of consecutively captured unfiltered images from the stream.

25. An image processing method, comprising:
applying an image filter to an unfiltered image to generate a first filtered image at an electronic device;
receiving input indicative of a location in the first filtered image from one or more sensors in communication with the electronic device;
associating an input parameter for a first image processing technique with the received input;
translating the received input from a location in the first filtered image to a corresponding location in the unfiltered image;
determining a relevant portion of the unfiltered image based on a characteristic of the image filter;
assigning a value to the input parameter based on the translated received input;
applying the first image processing technique based on the determined relevant portion of the unfiltered image to generate a second filtered image, the input parameter having the assigned value; and
storing the second filtered image in a memory.

26. The method of claim 25, wherein the first image processing technique comprises one of: auto exposure, auto focus, and auto white balance.

27. The method of claim 25, further comprising the act of:
receiving a stream of unfiltered images captured by a camera of the electronic device,
wherein the amount of image data captured by an image sensor of the camera is limited based on the determined relevant portion.

28. The method of claim 25, further comprising the act of displaying the second filtered image on a display.

29. The method of claim 25, wherein the act of translating the received input from a location in the first filtered image to a corresponding location in the unfiltered image comprises applying an inverse of the image filter to the location in the first filtered image.

30. The method of claim 25, wherein the act of translating the received input from a location in the first filtered image to a corresponding location in the unfiltered image comprises determining a position and size of a region in the unfiltered image.

31. The method of claim 25, wherein the act of translating the received input from a location in the first filtered image to a corresponding location in the unfiltered image is based on a characteristic of the image filter.

32. The method of claim 25, further comprising the acts of:
associating a first input parameter for the image filter with the received input;
assigning a first value to the first input parameter based on the received input; and
applying the image filter in conjunction with the first image processing technique based on the determined relevant portion of the unfiltered image to generate the second filtered image, the first input parameter having the first assigned value.

33. An apparatus comprising:
an image sensor for capturing an image representative of a scene;
a display;
a memory in communication with the image sensor; and
a programmable control device communicatively coupled to the image sensor, the display, and the memory, wherein the memory includes instructions for causing the programmable control device to perform the method of claim 1.

34. The apparatus of claim 33, wherein the display comprises a touch-sensitive display.

35. A computer usable medium having a computer readable program code embodied therein, wherein the computer readable program code is adapted to be executed to implement the method of claim 1.
